(19) United States
(12) Patent Application Publication
(10) Pub. No.: US 2018/0157759 A1
(43) Pub. Date: Jun. 7, 2018

(54) SYSTEMS AND METHODS FOR DETERMINATION AND PROVISION OF SIMILAR MEDIA CONTENT ITEM RECOMMENDATIONS

(71) Applicant: Facebook, Inc., Menlo Park, CA (US)

(72) Inventors: Chen Zheng, Cupertino, CA (US); Zhenghao Qian, Redwood City, CA (US); Linji Yang, Fremont, CA (US)

(21) Appl. No.: 15/370,815

(22) Filed: Dec. 6, 2016

(51) Int. Cl. G06F 17/30; G06Q 50/00; G06N 99/00

(52) U.S. Cl. CPC G06F 17/30867; G06N 99/005; G06Q 50/01; G06F 17/30991

(57) ABSTRACT

Systems, methods, and non-transitory computer-readable media can receive an indication that a user of a social networking system has interacted with a first media content item on the social networking system. A set of potential media content items is compiled based on media content item similarity criteria indicative of a similarity of each potential media content item to the first media content item. The set of potential media content items is ranked based on ranking criteria, and filtered based on filtering criteria. One or more similar media content item recommendations are presented to the user via a graphical user interface, the one or more similar media content item recommendations based on the ranking and the filtering.

### FIELD OF THE INVENTION

The present technology relates to the field of social networks. More particularly, the present technology relates to determination and provision of similar media content item recommendations.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with media content items posted to the social networking system by other users. For example, a user can view a photo or video posted by another user. The other user can be a friend of the user, or an entity that participates on the social networking system, or any other user of the social networking system. In addition to viewing the media content item, the user can further interact with a media content item by, for example, liking, commenting, or reacting to the media content item. A user's decision to interact with a particular media content item on the social networking system generally represents an indication of interest in the media content item. As the social networking system gains more information about the types of media content items a user interacts with, the social networking system gains knowledge about the user and can utilize that knowledge to optimize products and services offered to the user.

### SUMMARY

Various embodiments of the present disclosure can include systems, methods, and non-transitory computer readable media configured to receive an indication that a user of a social networking system has interacted with a first media content item on the social networking system. A set of potential media content items is compiled based on media content item similarity criteria indicative of a similarity of each potential media content item to the first media content item. The set of potential media content items is ranked based on ranking criteria, and filtered based on filtering criteria. One or more similar media content item recommendations are presented to the user via a graphical user interface, the one or more similar media content item recommendations based on the ranking and the filtering.

In an embodiment, each media content item similarity criterion of the media content item similarity criteria is associated with a subset of the set of potential media content items.

In an embodiment, the ranking the set of potential media content items based on ranking criteria comprises performing a first ranking of the set of potential media content media content items based on a first ranking criteria, and performing a second ranking of at least a subset of the set of potential media content items based on a second ranking criteria.

In an embodiment, the first ranking occurs before the filtering, and the second ranking occurs after the filtering.

In an embodiment, the first ranking is based on a user interaction probability determination.

In an embodiment, the likelihood that the user will interact with a potential media content item is determined based on a machine learning model.

In an embodiment, the second ranking is based on a visual similarity determination.

In an embodiment, the visual similarity determination is based on a machine learning model.

In an embodiment, the filtering criteria comprise a criterion relating to filtering out media content items that the user has already seen.

In an embodiment, the media content item similarity criteria comprise criteria relating to at least one of: an account similarity determination, a hashtag similarity determination, a location similarity determination, a co-like determination, an event similarity determination, or a visual similarity determination.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a media content item recommendation module, according to an embodiment of the present disclosure.

FIG. 2 illustrates an example media content item compilation module, according to an embodiment of the present disclosure.

FIG. 3 illustrates an example media content item ranking module, according to an embodiment of the present disclosure.

FIG. 4 illustrates an example method for providing similar media content item recommendations, according to an embodiment of the present disclosure.

FIG. 5 illustrates an example method for compiling a set of potential media content items, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Similar Media Content Item Recommendations

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can add friends or contacts, provide, post, or publish content items, such as text, notes, status updates, links, pictures, videos, and audio, via the social networking system.

Users of a social networking system can be given the opportunity to interact with media content items posted to the social networking system. For example, a user can view a photo or video posted by another user. The other user can be a friend of the user, or an entity that participates on the social networking system, or any other user of the social networking system. In addition to viewing a media content item, the user can further interact with the media content item by, for example, liking, commenting, or otherwise reacting to the media content item. A user's decision to interact with a media content item on the social networking system generally represents an indication of interest in the media content item. As the social networking system gains more information about the types of media content items a user interacts with, the social networking system gains knowledge about the user and can utilize that knowledge to optimize products and services offered to the user.

It continues to be an important interest for a social networking system to encourage interaction between users and content on the social networking system. Continued user interaction with content posted to the social networking is an important aspect of maintaining continued interest in and participation on the social networking system. However, given the abundance of content that may be available on a social networking system, it can be difficult to determine what types of content a user will be interested in and should be presented to the user. If users are not consistently presented with new and interesting content recommendations, or are presented with recommendations that they find uninteresting, growth in interactions between users and content on the social networking system may be impacted.

An improved approach rooted in computer technology overcomes the foregoing and other disadvantages associated with conventional approaches specifically arising in the realm of computer technology. Based on computer technology, the disclosed technology can determine media content items similar to a target media content item in which a user expresses interest, and recommend the similar media content items to the user. In this way, when a user expresses interest in the target media content item, e.g., by interacting with the target media content item on the social networking system, the user can be provided with similar media content item recommendations indicative of other media content items that the user may also be interested in. Throughout this disclosure, the term “similar” media content items, and the like, should be understood to mean media content items that a user may be interested in based on the user's expressed interest in a target media content item. Once a user has interacted with a target media content item, or otherwise expressed interest in the target media content item, a set of potential media content items can be determined. The set of potential media content items constitute media content items that are potentially similar to the target media content item. The set of potential media content items can be determined using various types of media content item similarity criteria. The set of potential media content items can then be ranked based on various ranking criteria. The set of potential media content items can also be filtered based on various filtering criteria. Once the set of potential media content items is ranked and filtered, the resulting set of similar media content items can be presented to the user as similar media content item recommendations. The user can be presented with a user interface for viewing, requesting, and/or interacting with the set of similar media content items.

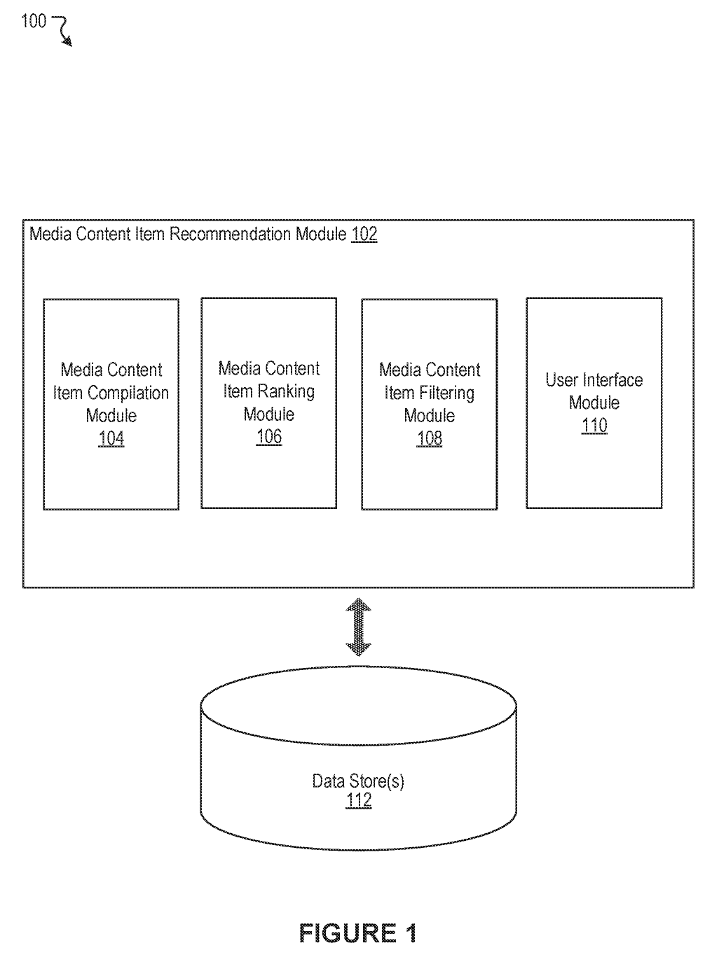

FIG. 1 illustrates an example system 100 including an example media content item recommendation module 102 configured to determine a set of media content items that are similar to a target media content item, and provide one or more similar media content item recommendations to a user, according to an embodiment of the present disclosure. The similar media content item recommendation module 102 can be configured to compile a set of potential media content items based on various types of media content item similarity criteria. Once a set of potential media content items is compiled, the set of potential media content items can be ranked based on one or more ranking criteria. In certain embodiments, the ranking criteria can be implemented, at least in part, using one or more machine learning models. For example, a machine learning model can be trained using previous interactions on the social networking system to determine which media content items a user is most likely to interact with based on various user characteristics and media content item characteristics, as will be discussed in greater detail herein. In this way, the machine learning model can provide tailored results for each user based, for example, on that user's characteristics and the media content item characteristics of the target media content item. The set of potential media content items can also be filtered based on various filtering criteria, and the resulting set of ranked, filtered similar media content items can be presented to the user as similar media content item recommendations. For example, if a user likes a first media content item on the social networking system, the user can be presented with a set of similar media content item recommendations comprising one or more media content items on the social networking system that the user may also be interested in viewing and/or interacting with based on the user's interaction with the first media content item.

As shown in the example of FIG. 1, the media content item recommendation module 102 can include a media content item compilation module 104, a media content item ranking module 106, a media content item filtering module 108, and a user interface module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

The media content item compilation module 104 can be configured to compile a set of potential media content items that are potentially similar to a target media content item. As will be described in greater detail below, a set of similar media content items can then be determined from the compiled set of potential media content items. In order to compile the set of potential media content items, some or all other media content items on a social networking system can be compared to the target media content item based on various types of media content item similarity criteria. The media content items that best satisfy the various types of media content item similarity criteria can then be included in the set of potential media content items. In certain embodiments, the media content item compilation module 104 can be configured to compile a plurality of subsets of the set of potential media content items based on various types of media content item similarity criteria. For example, if there are four different types of media content item similarity criteria being applied, the media content item compilation module 104 can select a first subset of potential media content items based on the first type of media content item similarity criteria, select a second subset of potential media content items based on the second type of media content item similarity criteria, and so forth for all four types of media content item similarity criteria. The four subsets of potential media content items selected can then be combined into a single set of potential media content items. The media content item compilation module 104 is discussed in greater detail herein.

The media content item ranking module 106 can be configured to rank the set of potential media content items based on various ranking criteria. In certain embodiments, the set of potential media content items can be ranked multiple times using different ranking criteria. For example, in certain embodiments, a first ranking can be performed based on a user interaction probability determination. The user interaction probability determination can be made by a machine learning model trained to determine the likelihood of a particular user interacting with a media content item if the media content item is presented as a similar media content item recommendation. The machine learning model can be trained using past social networking system interaction information to determine which media content items a user is most likely to interact with based on characteristics of the user and characteristics of the media content items. For example, the machine learning model can be trained based on past social networking system interaction information to determine the effect of various user characteristics and various media content item characteristics on the likelihood of a particular user to interact with a media content item if it is presented as a similar media content item recommendation. It should be understood that references to an interaction or interactions as used herein can include any activity involving a media content item, including but not limited to viewing, liking, sharing, commenting, etc. Once the model is trained, it can be provided with user information for a particular user, media content item information for a target media content item, and/or media content item information for a potential media content item in order to determine the likelihood that the particular user will interact with the potential media content item after having interacted with the target media content item and being presented with the potential medial content item as a similar media content item recommendation. Once each potential media content item from the set of potential media content items has been provided to the model, the set of potential media content items can be ranked based on the user interaction probability determination as determined by the model. Similarly, a second ranking can be performed based on a visual similarity determination. For example, a visual similarity machine learning model can be trained to determine visual similarity between media content items, and the set of potential media content items can be ranked based on visual similarity. It should be understood that although there is reference made to a “first” ranking and a “second” ranking, such references are not meant to confer any chronological order on the rankings, but rather to distinguish between rankings. As such, the “first” ranking could be performed after the “second” ranking, or vice versa. The media content item ranking module 106 is discussed in greater detail herein.

The media content item filtering module 108 can be configured to filter the set of potential media content items based on various filtering criteria. Depending on the implementation, the media content item filtering module 108 can be configured to filter before and/or after ranking of the set of potential media content items, or can filter between rankings, e.g., after a first ranking but before a second ranking. The media content item filtering module 108 can also be configured to filter the set of potential media content items more than once based on different filtering criteria. One example of filtering criteria can include an inappropriate content filter, e.g., a nudity filter that filters out media content items containing nudity, or a graphic content filter that filters out media content items containing content inappropriate for certain viewers. Another example of filtering criteria can include a previously seen content filter, in which media content items that were previously seen by a user (e.g., in the user's social networking system feed, or as a previous recommendation) can be filtered out for at least a period of time so that users are not presented with similar media content item recommendations that they have already seen recently.

The filtering criteria can also include filtering criteria based on visual similarity with a target media content item. For example, if a user has interacted with a target media content item that depicts one or more people, this may indicate that the user is interested in viewing media content items that contain people, and any media content items that do not contain people can be filtered out. Similarly, if a user has interacted with a target media content item that does not contain any people, this may indicate that the user is interested in viewing media content items that do not contain people, and any media content items that contain people can be filtered out.

The user interface module 110 can be configured to provide a graphical user interface for a user to request and/or view similar media content item recommendations. In certain embodiments, users can be presented with similar media content item recommendations based on actions taken by the user via the graphical user interface. For example, if a user “likes” a media content item, the user can automatically be presented with media content item recommendations based on the liked media content item. In another embodiment, the graphical user interface may include a recommendation icon proximate each media content item being viewed by the user, such that if the user selects the recommendation icon for a particular media content item, the user is presented with media content item recommendations similar to the particular media content item. In another embodiment, whenever the user opens a media content item for viewing (e.g., by tapping on the media content item), a list of similar media content item recommendations can be automatically populated below or next to the media content item so that the user can scroll vertically or horizontally to view the similar media content item recommendations. In yet another embodiment, similar media content item recommendations can be provided based on the duration or pressure of a user's tap, e.g., a long tap or hard pressure results in similar media content item recommendations being presented.

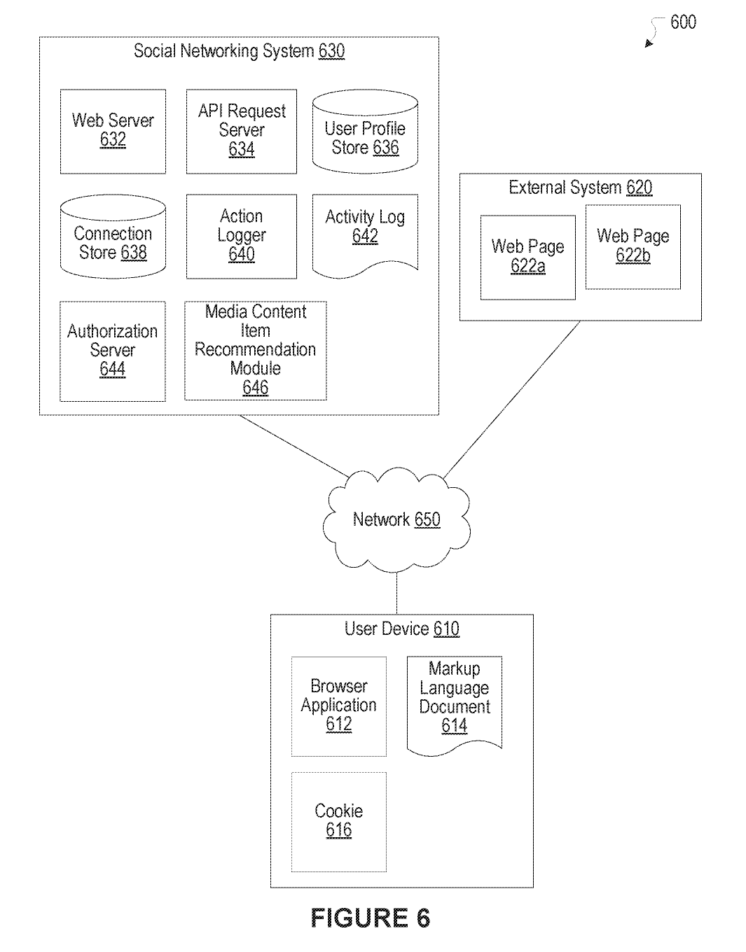

The media content item recommendation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the media content item recommendation module 102 can be implemented, in part or in whole, as software running on one or more computing devices or systems, such as on a server computing system or a user (or client) computing system. For example, the media content item recommendation module 102 or at least a portion thereof can be implemented as or within an application (e.g., app), a program, or an applet, etc., running on a user computing device or a client computing system, such as the user device 610 of FIG. 6. In another example, the media content item recommendation module 102 or at least a portion thereof can be implemented using one or more computing devices or systems that include one or more servers, such as network servers or cloud servers. In some instances, the media content item recommendation module 102 can, in part or in whole, be implemented within or configured to operate in conjunction with a social networking system (or service), such as the social networking system 630 of FIG. 6. It should be understood that there can be many variations or other possibilities.

The media content item recommendation module 102 can be configured to communicate and/or operate with the at least one data store 112, as shown in the example system 100. The data store 112 can be configured to store and maintain various types of data. In some implementations, the data store 112 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 112 can store information that is utilized by the media content item recommendation module 102. For example, the data store 112 can store historical social networking system interaction information, media content item similarity criteria, media content item ranking criteria, one or more machine learning models, media content item filtering criteria, and the like. It is contemplated that there can be many variations or other possibilities.

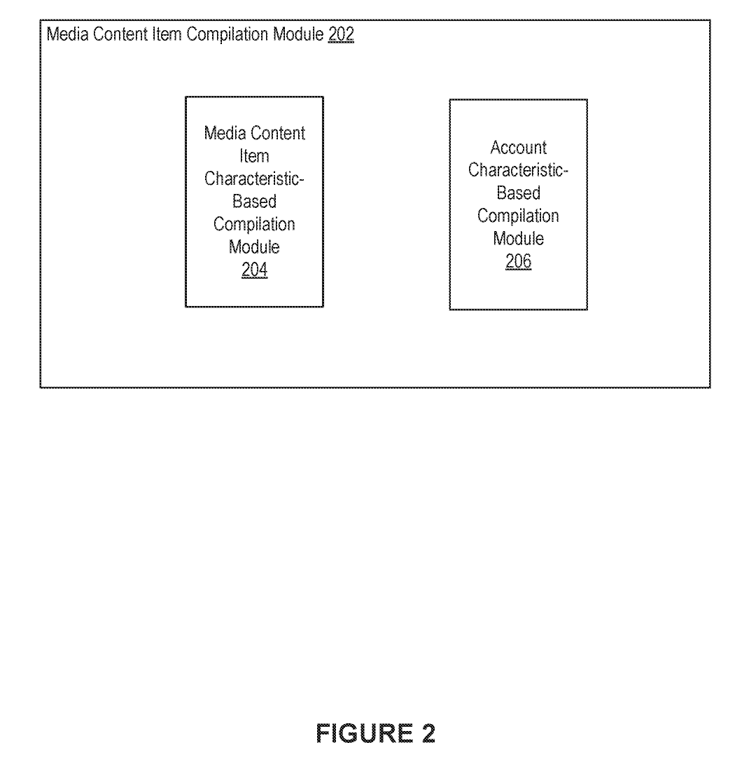

FIG. 2 illustrates an example media content item compilation module 202 configured to compile a set of potential media content items, according to an embodiment of the present disclosure. In some embodiments, the media content item compilation module 104 of FIG. 1 can be implemented as the example media content item compilation module 202. As shown in FIG. 2, the media content item compilation module 202 can include a media content item characteristic-based compilation module 204 and an account characteristic-based compilation module 206. In certain embodiments, as described in greater detail below, each of the modules 204 and 206 contained in the media content item compilation module 202 can apply one or more types of media content item similarity criteria for determining a subset of the set of potential media content items.

The media content item characteristic-based compilation module 204 can be configured to determine one or more media content items for inclusion in the set of potential media content items based on similarity criteria related to media content item characteristics. For example, a subset of the set of potential media content items can be selected based on a visual similarity determination. Media content items that are visually similar to a target media content item, or depict content similar to the target media content item (e.g., photos of dogs, or photos of sunsets) can be selected for inclusion in the set of potential media content items.

In another example, a subset of the set of potential media content items can be determined based on location information, or a similar location determination. Location information associated with each media content item can be compared to location information associated with the target media content item, and the top media content items having similar location information to the target media content item can be added to the set of potential media content items. In certain embodiments, the “top” media content items can be based on user interaction information, e.g., media content items with the most likes and/or comments. For example, if a target media content item is associated with a particular location, the top twenty most popular media content items associated with the same location can be included in the set of potential media content items. Location information can be determined based on geo-tagging information associated with the media content item, or based on a user location tag.

Similarly, a subset of the set of potential media content items can be determined based on event information, or a similar event determination. For example, if the target media content item is associated with a particular event (e.g., the Super Bowl, or March Madness), then the top media content items that are also associated with the same event, or a similar event, can be included in the set of potential media content items.

In another example, a subset of the set of potential media content items can be determined based on a co-like determination. The co-like determination can be indicative of a similarity in the viewing and/or interacting audiences of a media content item with the target media content item. For example, the number and/or ratio of users who liked the target media content item and also liked another media content item can be determined for some or all media content items on the social networking system, and the media content items with the highest number or ratio of overlapping users can be included in the set of potential media content items.

In yet another example, a subset of the set of potential media content items can be determined based on media content items having similar hashtags to the target media content item, i.e., a similar hashtag determination. In certain embodiments, media content items can be associated with many hashtags. Certain hashtags can be preferred over others based on a concept specificity determination. This can be accomplished, for example, using a term frequency-inverse document frequency (tf-idf) calculation. This feature can be useful in determining which hashtags are more reliable for determining similarity to the target media content item. For example, the hashtag “#tbt” (i.e., “throw back Thursday”) is not related to any particular concept, and a media content item tagged with the “#tbt” hashtag could include anything from a sporting event, to a vacation resort, to a family portrait. Conversely, a more specific hashtag, such as “#vegas” or “#dogsofinstagram” or more closely associated with a particular concept, and may be more useful in determining similar media content items.

The account characteristic-based compilation module 206 can be configured to determine one or more media content items for inclusion in the set of potential media content items based on various types of media content item similarity criteria related to account characteristics. For example, the account characteristic-based compilation module 206 can be configured to determine one or more accounts on a social networking system that are similar to the target account that posted the target media content item. The similar account determination can be based on various account characteristics, e.g., co-like or co-follower information indicative of the similarity of the social graphs of a target account and a potentially similar account, historical follow-through information indicative of how likely users have been to follow the potentially similar account when it was recommended based on interaction with the target account; historical search co-visitation information indicative of how often users have visited both the potentially similar account and the target account based on a single search operation, and the like. A selection of media content items (e.g., the most popular media content items) from the one or more similar accounts can be included in the set of potential media content items.

As can be seen from the discussion above, several different types of media content item similarity criteria can be utilized to determine the set of potential media content items, with each type of media content item similarity criteria being associated with a subset of the set of potential media content items. The various similarity criteria can be weighted differently, such that one similarity criteria is favored over another. For example, the top fifty visually similar media content items can be included in the set of potential media content items, whereas only the top ten media content items with similar hashtags are included. Furthermore, rather than a ranking threshold for each similarity criteria (e.g., the top fifty, or the top ten of a particular group), a threshold score can be implemented for any of the similarity criteria described above. For example, rather than including the top fifty visually similar content items in the set of potential media content items, all media content items having a visual similarity score greater than a threshold score can be included.

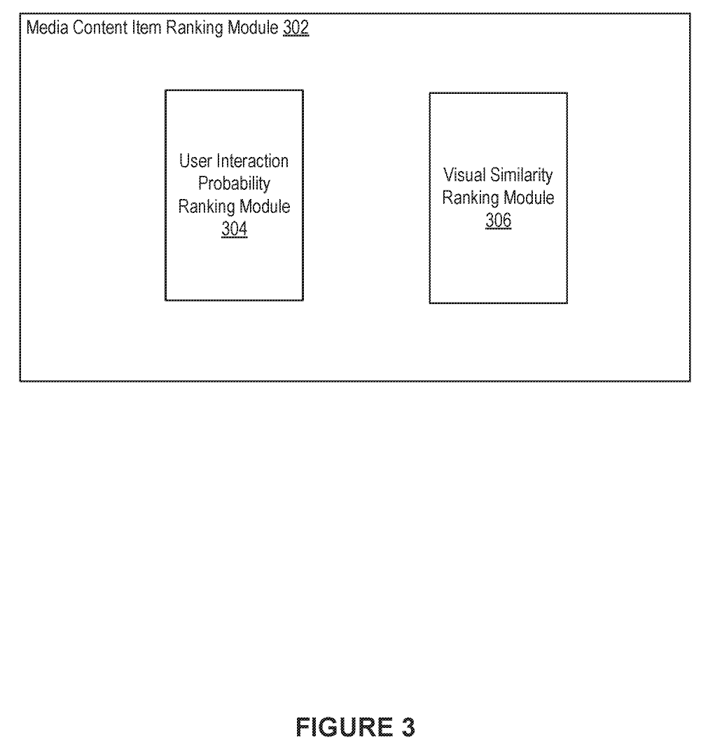

FIG. 3 illustrates an example media content item ranking module 302 configured to rank one or more media content items, e.g., the set of potential media content items, according to an embodiment of the present disclosure. In some embodiments, the media content item ranking module 106 of FIG. 1 can be implemented as the example media content item ranking module 302. As shown in FIG. 3, the media content item ranking module 302 can include a user interaction probability ranking module 304 and a visual similarity ranking module 306.

The user interaction probability ranking module 304 can be configured to make a user interaction probability determination, indicative of the likelihood of a user to interact with a media content item if the media content item is recommended to the user after the user has interacted with a target media content item. This user interaction probability determination can be made based on a machine learning model. The machine learning model can be trained using historical social network interaction information to determine the likelihood that a user will interact with a media content item if the media content item is recommended to the user after the user has interacted with a target media content item. The machine learning model can determine the likelihood of user interaction based on various user characteristics associated with the user, various media content item characteristics associated with the media content item, and various target media content item characteristics associated with the target media content item. User characteristics can include any number of user characteristics believed to be relevant to the ultimate determination of likelihood to interact with a similar media content item recommendation. These can include, for example, user demographic information (e.g., age, income, location of residence), user social graph information (e.g., number of friends or followers), the number of the user's friends who have also liked or otherwise interacted with the particular media content item and/or the target media content item, etc. Similarly, media content item characteristics and target media content item characteristics can include any characteristics that are believed to be relevant to the ultimate determination of likelihood of a user to interact with the particular media content item after interacting with the target media content item. This can include, for example, total number of interactions with each media content item (e.g., likes, shares, comments), the number of interactors the particular media content item and the target media content item have in common, the number of the user's friends or followers who have also interacted with the target media content item and/or the particular media content item, demographic information for the interactors of the particular media content item and/or the target media content item, and the like. The set of potential media content items can be ranked based on the machine learning model and/or the user interaction probability determination. In certain embodiments, the ranking of the set of potential media content items comprises a LambdaMART ranking algorithm.

The visual similarity ranking module 306 can be configured to rank media content items based on a visual similarity determination. In certain embodiments, the visual similarity determination can be made based on a machine learning model. For example, the machine learning model can be trained to identify what objects are depicted in a media content item, or to determine, for each of a plurality of objects or concepts, the likelihood that the object or concept is depicted in the media content item. Media content items depicting similar objects and/or concepts can be given a higher visual similarity score or ranking. The model can be trained to determine visual similarity across media content item types, such as video, still images, and/or moving images. In certain embodiments, videos and/or moving images can be compared to other media content items based on a thumbnail or single frame of the video and/or moving image.

In certain embodiments, the set of potential media content items can first be ranked by the user interaction probability ranking module 304, and then filtered by the filtering module 108. A set of similar media content items can be defined by this first ranking and filtering. For example, once the media content item compilation module 202 has compiled the set of potential media content items, the set of potential media content items can be ranked based on user interaction probability, and then the top fifty media content items can be selected (i.e., any media content items ranked lower than fifty are filtered out) to define the set of similar media content items. The set of similar media content items can then be re-ranked based on the visual similarity determination such that the most visually similar media content items are ranked more highly. In another embodiment, the visual similarity determination can provide a rankings “boost” to potential media content items, e.g., by increasing a similarity score based on the visual similarity of a potential media content item to the target media content item. Similar media content item recommendations can then be presented to a user based on the ranked, filtered set of similar media content items.

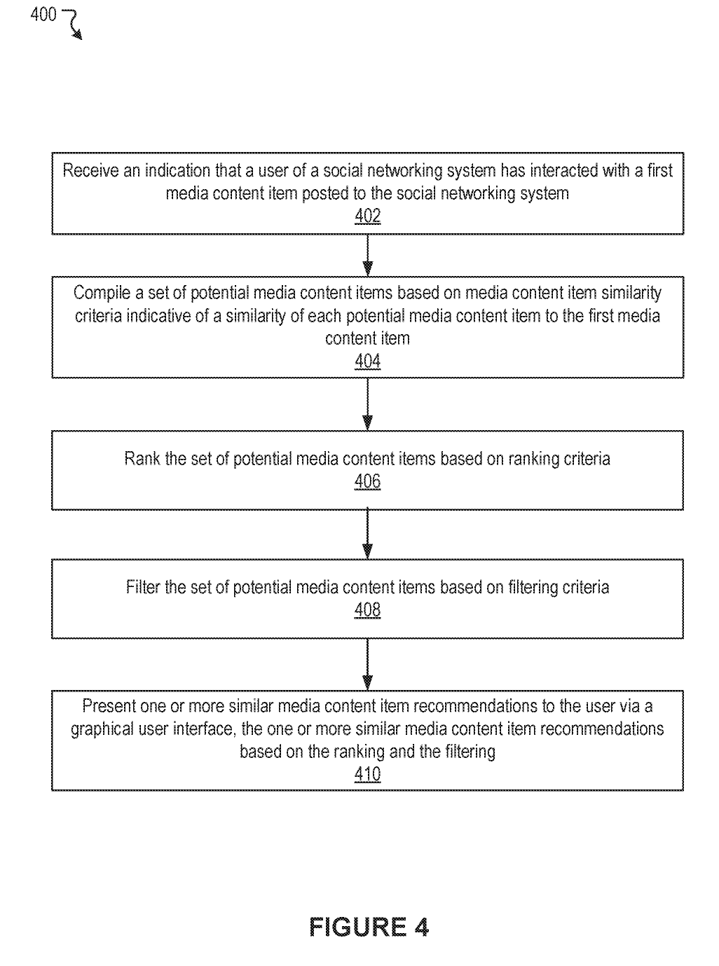

FIG. 4 illustrates an example method 400 associated with providing similar media content item recommendations, according to an embodiment of the present disclosure. It should be appreciated that there can be additional, fewer, or alternative steps performed in similar or alternative orders, or in parallel, based on the various features and embodiments discussed herein unless otherwise stated.

At block 402, the example method 400 can receive an indication that a user of a social networking system has interacted with a first media content item posted to the social networking system. At block 404, the example method 400 can compile a set of potential media content items based on media content item similarity criteria indicative of a similarity of each potential media content item to the first media content item. At block 406, the example method 400 can rank the set of potential media content items based on ranking criteria. At block 408, the example method 400 can filter the set of potential media content items based on filtering criteria. At block 410, the example method 400 can present one or more similar media content item recommendations to the user via a graphical user interface, the one or more similar media content item recommendations based on the ranking and the filtering. Other suitable techniques that incorporate various features and embodiments of the present technology are possible.

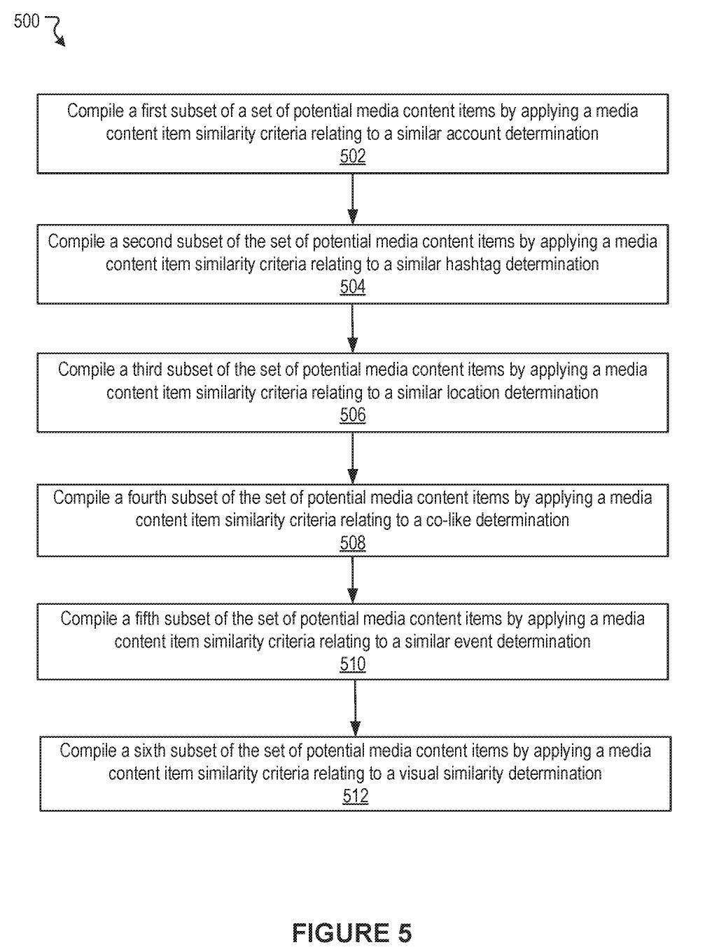

FIG. 5 illustrates an example method 500 associated with compiling a set of potential media content items, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can compile a first subset of a set of potential media content items by applying a media content item similarity criteria relating to a similar account determination. At block 504, the example method 500 compile a second subset of the set of potential media content items by applying a media content item similarity criteria relating to a similar hashtag determination. At block 506, the example method 500 can compile a third subset of the set of potential media content items by applying a media content item similarity criteria relating to a similar location determination. At block 508, the example method 500 can compile a fourth subset of the set of potential media content items by applying a media content item similarity criteria relating to a co-like determination. At block 510, the example method 500 can compile a fifth subset of the set of potential media content items by applying a media content item similarity criteria relating to a similar event determination. At block 512, the example method 500 can compile a sixth subset of the set of potential media content items by applying a media content item similarity criteria relating to a visual similarity determination. Other suitable techniques that incorporate various features and embodiments of the present technology are possible.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a media content item recommendation module 646. The media content item recommendation module 646 can, for example, be implemented as the media content item recommendation module 102, as discussed in more detail herein. As discussed previously, it should be appreciated that there can be many variations or other possibilities. For example, in some embodiments, one or more functionalities of the media content item recommendation module 646 can be implemented in the user device 610.

### Hardware Implementation

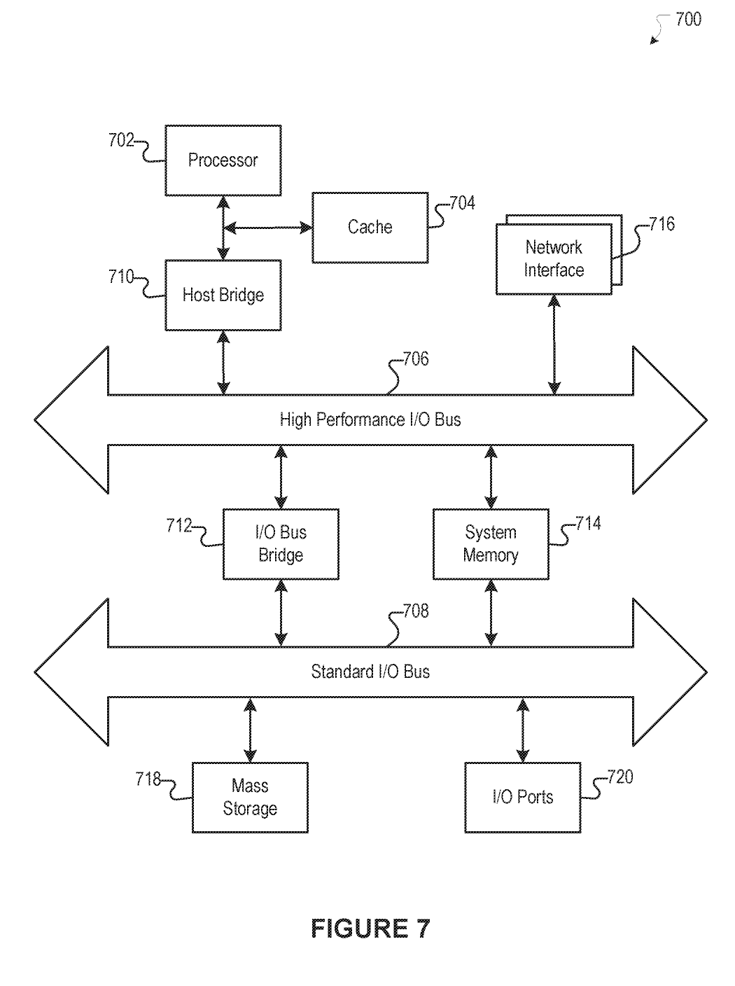

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, an indication that a user of a social networking system has interacted with a first media content item on the social networking system;
compiling, by the computing system, a set of potential media content items based on media content item similarity criteria indicative of a similarity of each potential media content item to the first media content item;
ranking, by the computing system, the set of potential media content items based on ranking criteria;
filtering, by the computing system, the set of potential media content items based on filtering criteria; and
presenting, by the computing system, one or more similar media content item recommendations to the user via a graphical user interface, the one or more similar media content item recommendations based on the ranking and the filtering.

2. The computer-implemented method of claim 1, wherein each media content item similarity criterion of the media content item similarity criteria is associated with a subset of the set of potential media content items.

3. The computer-implemented method of claim 1, wherein the ranking the set of potential media content items based on ranking criteria comprises
performing a first ranking of the set of potential media content media content items based on a first ranking criteria, and
performing a second ranking of at least a subset of the set of potential media content items based on a second ranking criteria.

4. The computer-implemented method of claim 3, wherein the first ranking occurs before the filtering, and the second ranking occurs after the filtering.

5. The computer-implemented method of claim 4, wherein the first ranking is based on a user interaction probability determination.

6. The computer-implemented method of claim 5, wherein the likelihood that the user will interact with a potential media content item is determined based on a machine learning model.

7. The computer-implemented method of claim 3, wherein the second ranking is based on a visual similarity determination.

8. The computer-implemented method of claim 1, wherein the visual similarity determination is based on a machine learning model.

9. The computer-implemented method of claim 1, wherein the filtering criteria comprise a criterion relating to filtering out media content items that the user has already seen.

10. The computer-implemented method of claim 1, wherein the media content item similarity criteria comprise criteria relating to at least one of: an account similarity determination, a hashtag similarity determination, a location similarity determination, a co-like determination, an event similarity determination, or a visual similarity determination.

11. A system comprising:
at least one processor; and
a memory storing instructions that, when executed by the at least one processor, cause the system to perform a method comprising:
receiving an indication that a user of a social networking system has interacted with a first media content item on the social networking system;
compiling a set of potential media content items based on media content item similarity criteria indicative of a similarity of each potential media content item to the first media content item;
ranking the set of potential media content items based on ranking criteria;
filtering the set of potential media content items based on filtering criteria; and
presenting one or more similar media content item recommendations to the user via a graphical user interface, the one or more similar media content item recommendations based on the ranking and the filtering.

12. The system of claim 11, wherein each media content item similarity criterion of the media content item similarity criteria is associated with a subset of the set of potential media content items.

13. The system of claim 11, wherein the ranking the set of potential media content items based on ranking criteria comprises
performing a first ranking of the set of potential media content media content items based on a first ranking criteria, and
performing a second ranking of at least a subset of the set of potential media content items based on a second ranking criteria.

14. The system of claim 13, wherein the first ranking occurs before the filtering, and the second ranking occurs after the filtering.

15. The system of claim 14, wherein the first ranking is based on a user interaction probability determination.

16. A non-transitory computer-readable storage medium including instructions that, when executed by at least one processor of a computing system, cause the computing system to perform a method comprising:
receiving an indication that a user of a social networking system has interacted with a first media content item on the social networking system;
compiling a set of potential media content items based on media content item similarity criteria indicative of a similarity of each potential media content item to the first media content item;
ranking the set of potential media content items based on a machine learning model;
filtering the set of potential media content items based on filtering criteria; and
presenting one or more similar media content item recommendations to the user via a graphical user interface, the one or more similar media content item recommendations based on the ranking and the filtering.

17. The non-transitory computer-readable storage medium of claim 16, wherein each media content item similarity criterion of the media content item similarity criteria is associated with a subset of the set of potential media content items.

18. The non-transitory computer-readable storage medium of claim 16, wherein the ranking the set of potential media content items based on ranking criteria comprises
performing a first ranking of the set of potential media content media content items based on a first ranking criteria, and
performing a second ranking of at least a subset of the set of potential media content items based on a second ranking criteria.

19. The non-transitory computer-readable storage medium of claim 18, wherein the first ranking occurs before the filtering, and the second ranking occurs after the filtering.

20. The non-transitory computer-readable storage medium of claim 19, wherein the first ranking is based on a user interaction probability determination.
